(19) United States
(12) Patent Application Publication
(10) Pub. No.: US 2014/0285304 A1
(43) Pub. Date: Sep. 25, 2014

(54) INDUCTOR AND METHOD FOR MANUFACTURING THE SAME

(71) Applicant: Samsung Electro-Mechanics Co., Ltd., Suwon-si (KR)

(72) Inventors: Young Seuck YOO, Suwon-si (KR); Young Do KWEON, Suwon-si (KR); Kang Heon HUR, Suwon-si (KR); Jin Hyuck YANG, Suwon-si (KR); Sung Kwon WI, Suwon-si (KR); Jong Yun LEE, Suwon-si (KR)

(73) Assignee: SAMSUNG ELECTRO-MECHANICS CO., LTD., Suwon-si (KR)

(21) Appl. No.: 14/054,553

(22) Filed: Oct. 15, 2013

(30) Foreign Application Priority Data
Mar. 25, 2013 (KR) 10-2013-0031563

(51) Int. Cl. H01F 27/28

(52) U.S. Cl. CPC H01F 27/2804
USPC 336/200

(57) ABSTRACT

Disclosed herein is an inductor including: a core layer having a conductive pattern formed on a surface thereof and having a through-hole formed at a region in which the conductive pattern is not formed; and a magnetic layer covering the core layer, wherein the magnetic layer includes: a filled part filled in the through-hole and having high magnetic material filling density; and a cover part covering the surface of the core layer and having magnetic material filling density lower than that of the filled part.

CROSS REFERENCE(S) TO RELATED APPLICATIONS

This application claims the benefit under 35 U.S.C. Section 119 of Korean Patent Application Serial No. 10-2013-0031563, entitled “Inductor and Method for Manufacturing the Same” filed on Mar. 25, 2013, which is hereby incorporated by reference in its entirety into this application.

### BACKGROUND OF THE INVENTION

1. Technical Field

The present invention relates to an inductor and a method for manufacturing the same, and more particularly, to an inductor having improved inductance characteristics, and a method for manufacturing the same.

2. Description of the Related Art

A multilayer type power inductor is mainly used in a power supply circuit such as a direct current (DC) to DC converter in a portable electronic apparatus. Particularly, the multilayer type power inductor is used at a high current due to a feature of suppressing magnetic saturation in view of a material and a structure. The multilayer type power inductor has a disadvantage in that a change in an inductance (L) value according to application of a current is large as compared with a winding type power inductor, but is advantageous for miniaturization and thinness, such that the multilayer type power inductor may comply with the recent trend of an electronic component.

A general multilayer power inductor is configured to include a core layer in which a coil type internal circuit pattern is formed, a magnetic layer covering the core layer, external electrodes covering both end portions of the magnetic layer, and the like. Here, as an area occupied by the magnetic layer in the multilayer power inductor increases, magnetic permeability is improved, such that inductance characteristics may be improved. Therefore, the inductor may be configured in a structure in which a through-hole is formed in a region of the core layer in which the circuit pattern is not formed and is then filled with a metal-resin composite to increase an occupancy area of the magnetic layer.

However, as described above, in the case of performing a process so that the metal-resin composite covers both surfaces of the core layer while being filled in the through-hole, the metal-resin composite is not effectively filled in the through-hole, such that magnetic material filling density of a core part of the magnetic layer filled in the through-hole is decreased. In this case, the magnetic material filling density for a through-hole part of the core layer is decreased, such that the entire magnetic permeability of the magnetic layer is decreased, thereby deteriorating inductance characteristics of the manufactured inductor.

### RELATED ART DOCUMENT

### Patent Document

(Patent Document 1) Korean Patent Laid-Open Publication No. 2004-0107408

### SUMMARY OF THE INVENTION

An object of the present invention is to provide an inductor having improved inductance characteristics, and a method for manufacturing the same.

Another object of the present invention is to provide an inductor in which the entire magnetic permeability of a magnetic layer is increased by improving magnetic material filling density of a filled part filled in a through-hole of a core layer in a magnetic layer of the inductor, and a method for manufacturing the same.

According to an exemplary embodiment of the present invention, there is provided an inductor including: a core layer having a conductive pattern formed on a surface thereof and having a through-hole formed at a region in which the conductive pattern is not formed; and a magnetic layer covering the core layer, wherein the magnetic layer includes: a filled part filled in the through-hole and having high magnetic material filling density; and a cover part covering the surface of the core layer and having magnetic material filling density lower than that of the filled part.

Each of the filled part and the cover part may be made of a metal-resin composite, and the magnetic material filling density of the filled part may be 5.49 g/cm³ or more.

A content of a resin in a metal-resin composite for manufacturing the filled part may be less than 3.5 wt % based on the metal-resin composite.

The filled part and the cover part may be made of a metal-resin composite, wherein the metal-resin composite includes a metal containing iron (Fe) and a thermosetting resin.

The filled part may be formed by filling a metal-resin composite in the through-hole before the cover part is formed.

The filled part and the cover part may contact each other while forming an interface therebetween.

According to another exemplary embodiment of the present invention, there is provided a method for manufacturing an inductor, including: preparing a core substrate; preparing a core layer by forming a through-hole in the core substrate; forming a filled part in the through-hole by filling a first metal-resin composite in the through-hole, the first metal-resin composite having a relatively high magnetic material content; and forming a cover part by forming a second metal-resin composite on the core layer and the filled part, the second metal-resin composite having a magnetic material content lower than that of the first metal-resin composite.

The first and second metal-resin composites may include a metal containing iron (Fe) and a thermosetting resin, respectively, and a content of the metal may be higher in the first metal-resin composite than in the second metal-resin composite.

In the forming of the filled part, a screen printing process may be performed on the core layer.

A content of a resin in the first metal-resin composite may be less than 3.5 wt % based on the first metal-resin composite.

The preparing of the core layer may include: preparing a copper clad laminate (CCL); and forming the through-hole in the copper clad laminate.

The method may further include, before the forming of the cover part, patterning a metal layer formed on a surface of the core layer.

According to still another exemplary embodiment of the present invention, there is provided a method for manufacturing an inductor including a core layer having a conductive pattern formed on a surface thereof and having a through-hole formed at a region in which the conductive pattern is not formed, a magnetic layer including a filled part filled in the through-hole and a cover part other than the filled part, and an external electrode formed on an end portion of the magnetic layer, wherein the filled part is formed by a process separate from a process of forming the cover part before the process of forming the cove part.

The filled part may include a high magnetic material content higher than that of the cover part.

The core layer may be formed by forming the through-hole in a copper clad laminate and patterning a metal layer on a surface of the copper clad laminate.

### BRIEF DESCRIPTION OF THE DRAWINGS

FIG. 1 is a view showing an inductor according to an exemplary embodiment of the present invention;

FIG. 2 is a flow chart showing a method for manufacturing an inductor according to the exemplary embodiment of the present invention; and

FIGS. 3A to 3D are views for describing a process for manufacturing an inductor according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to exemplary embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In the drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes For example, an etching region vertically shown may be rounded or may have a predetermined curvature.

Hereinafter, an inductor and a method for manufacturing the same according to exemplary embodiments of the present invention will be described in detail with reference to the accompanying drawings.

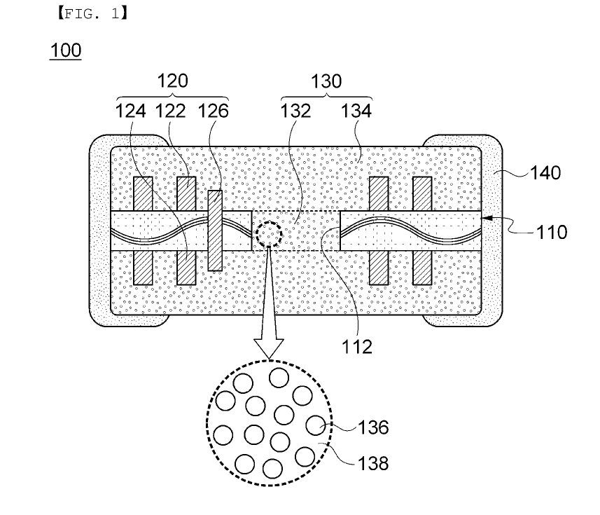

FIG. 1 is a view showing an inductor according to an exemplary embodiment of the present invention. Referring to FIG. 1, the inductor 100 according to the exemplary embodiment of the present invention, which is a multilayer power inductor, may be configured to include a core layer 110, a conductive pattern 120, a magnetic layer 130, and an external electrode 140.

The core layer 110 may be a base substrate for manufacturing the inductor 100. The core layer 110 may have at least one through-hole 112 penetrating therethrough. The through-hole 112 may be generally provided at a central region of the core layer 110 in which the conductive pattern 120 is not formed. The through-hole 112, which is provided in order to increase an occupancy area of the magnetic layer 130 in the inductor 100, may be filled with predetermined magnetic powders.

The conductive pattern 120 may be formed on both surfaces of the core layer 110. As an example, the conductive pattern 120 may include a first pattern 122 formed on one surface of the core layer 110, a second pattern 124 formed on the other surface of the core layer 110, which is opposite to one surface of the core layer 110, and a connector 126 penetrating through the core layer 110 so as to electrically connect the first and second patterns 122 and 124 to each other. The conductive pattern 120 having the above-mentioned structure may form at least one coil on the core layer 110. The conductive pattern 120 may be made of various metal materials. As an example, the conductive pattern 120 may be made of silver (Ag) or copper (Cu).

The magnetic layer 130 may cover both surfaces of the core layer 110 while being filled in the through-hole 112. The magnetic layer 130 may be configured of a filled part 132 filled in the through-hole 112 and a cover part 134 covering both surfaces of the core layer 110. The magnetic layer 130 having the above-mentioned structure may configure a device body of the inductor 100 having substantially a hexahedral shape.

The external electrode 140 may have a structure in which it covers both end portions of an outer portion of the device body while being electrically connected to the conductive pattern 120. The external electrode 140 may be used as an external connection terminal for electrically connecting the inductor 100 to an external electronic apparatus (not shown).

Meanwhile, the magnetic layer 130 may be made of a metal-resin composite material. For example, the metal-resin composite may be a metal-resin composite including metal magnetic powders 136 and a thermosetting resin 138 that is in a non-cured state. As the metal magnetic powders 136, various metal powders having magnetism may be used, and as the thermosetting resin 138, an amorphous epoxy resin may be used. As the metal magnetic powders 136, metal powders using iron (Fe) or an iron alloy as a base material may be used.

The amorphous epoxy resin may be more easily manufactured in a film shape as compared with a crystalline epoxy resin such as biphenyl type epoxy. Particularly, in the case in which a novolak based epoxy resin or a rubber based polymer epoxy resin having a molecular weight of 15000 or more, it may be very easily manufactured in a film shape. In addition, as the thermosetting resin, polyimide, liquid crystal polymer (LCP), or the like, may also be used. The thermosetting resin as described above may have a content of about 2.0 to 5.0 wt % based on a weight of the metal resin composite.

In addition, the metal magnetic powders 135 may have a content of about 75 to 98 wt % based on the metal-resin composite. In the case in which the content of the metal magnetic powders is less than about 75 wt % based on the metal-resin composite, a content of the thermosetting resin 138, which is a non-magnetic material, is relatively increased, such that the magnetic layer 130 may serve to hinder a flow of a magnetic flux for implementing characteristics of the inductor 100. Usually, it was configured that in the case in which only the content of the metal magnetic powders 136 is less than about 75 wt % based on the metal-resin composite in the state in which other conditions are the same as each other, an inductance value of the inductor is decreased by about 30% as compared with a design value. On the other hand, in the case in which the content of the metal magnetic powders 136 exceeds about 98 wt % based on the metal-resin composite, a physical property of the metal-resin composite is in a state in which it is difficult to manufacture a magnetic film for manufacturing the magnetic layer 130, such that a yield of the magnetic film may be significantly decreased.

Meanwhile, the filled part 132 of the magnetic layer 130 may have magnetic material filling density higher than that of the cover part 134. For example, the filled part 132 may be formed using a metal-resin composite having a content of metal magnetic powders relatively higher than that of the metal-resin composite for forming the cover part 134. That is, the filled part 132 may be formed by a process separate from a process of forming the cover part 134. Therefore, an interface may be present on a contact part between the filled part 132 and the cover part 134. In this case, since the filled part 132 has a content of the metal magnetic powders higher than that of the cover part 134 to increase magnetic permeability, thereby making it possible to increase an inductance (L) value of the inductor 110.

As described above, the inductor 100 according to the exemplary embodiment of the present invention may be configured to include the core layer 110 having the conductive pattern 120 formed on a surface thereof, the magnetic layer 130 covering the core layer 110, and the external electrode 140 covering both end portions of an outer portion of the magnetic layer 130, wherein the magnetic layer 130 includes the filled part 132 filled in the through-hole 112 formed in the core layer 110 and having relatively high magnetic material filling density and the cover part 134 covering both surfaces of the core layer 110 and having magnetic material filling density lower than that of the filled part 132. Contrary to an existing inductor in which magnetic material filling efficiency of an inductor core portion is low, such that the entire magnetic permeability is decreased, in the inductor 110 having the above-mentioned structure, the magnetic material filling density in the core layer 110 may be increased. Therefore, since the inductor according to the exemplary embodiment of the present invention has a structure in which the magnetic layer filled in the core layer has relatively high magnetic material filling density, it may have a structure in which magnetic permeability thereof is increased to improve inductance characteristics.

Hereinafter, a method for manufacturing an inductor according to the exemplary embodiment of the present invention will be described in detail. Here, a description of configurations overlapped with those of the inductor 100 described above may be omitted or simplified.

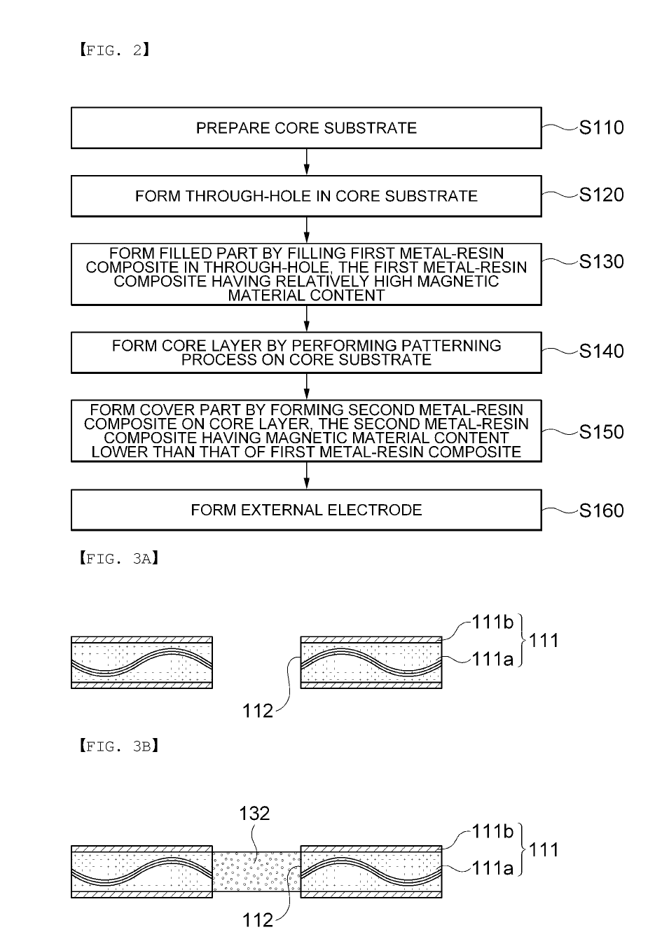

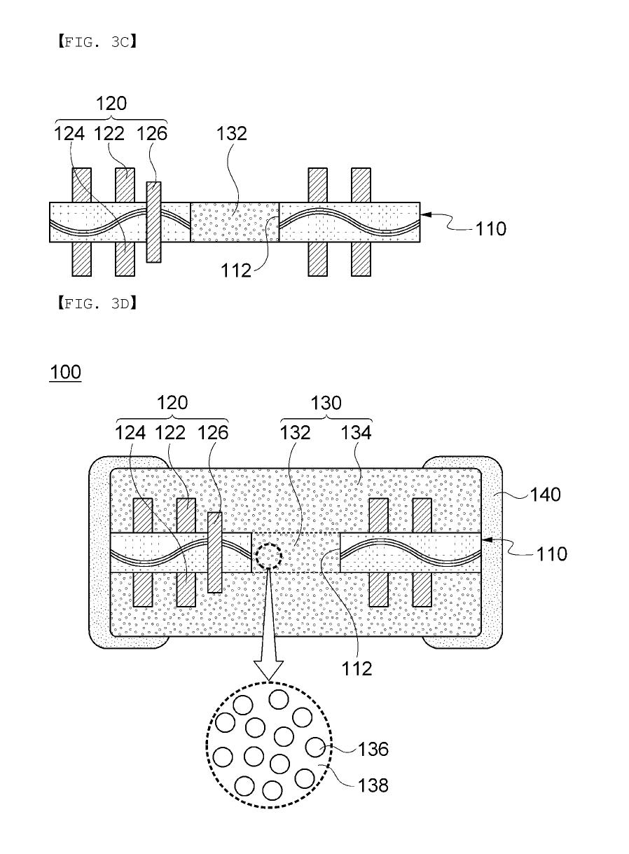

FIG. 2 is a flow chart showing a method for manufacturing an inductor according to the exemplary embodiment of the present invention; and FIGS. 3A to 3D are views for describing a process for manufacturing an inductor according to the exemplary embodiment of the present invention.

Referring to FIGS. 2 and 3A, a core substrate 111 may be prepared (S110). In the preparing of the core substrate 111, a substrate including an insulating layer 111a and metal layers 111b covering both surfaces of the insulating layer 111a may be prepared. As an example, a copper clad laminate (CCL) may be used as the core substrate 110.

The through-hole 112 may be formed in the core substrate 110 (S120). In the forming of the through-hole 112, a laser processing process, a drilling processing process, or the like, may be performed on the copper clad laminate. The through-hole 112 may be generally formed in a central region of the core substrate 110.

Referring to FIGS. 2 and 3B, the filled part 132 may be formed by filling a first metal-resin composite in the through-hole 112 (S130), the first metal-resin composite having a relatively high magnetic material content. For example, in the forming of the filled part 132, the first metal-resin composite may be prepared and be then filled in the through-hole 112 by performing a screen printing method on the core substrate 110 in which the through-hole 112 is formed.

Referring to FIGS. 2 and 3C, the core layer 110 may be formed by performing a patterning process on the core substrate 111 (S140). In the forming of the core layer 110, a plating process using a plating prevention pattern, an etching process, a photolithography process, and the like, may be selectively performed on the metal layer 111b of the core substrate 110 to remove a portion of the metal layer 111b. Therefore, a non-circuit pattern of the metal layer 111b is removed, such that the conductive pattern 120 including the first pattern 122 covering one surface of the insulating layer 111a, the second pattern 124 covering the other surface of the core layer 110, which is opposite to one surface of the core layer 110, and the connector 126 connecting the first and second patterns 122 and 124 to each other may be formed. The conductive pattern 120 may be formed in one coil shape on the core layer 110.

Referring to FIGS. 2 and 3D, the cover layer 134 may be formed by forming a second metal-resin composite on the core layer 110 (S150), the second metal-resin composite having a magnetic material content lower than that of the first metal-resin composite. In the forming of the cover layer 134, the second metal-resin composite may be prepared and be coated on both surfaces of the core layer 110 and the filled part 132. Therefore, the magnetic layer 130 including the filled part 132 filled in the through-hole 112 and the cover part 134 covering both surfaces of the core layer 110 and the filled part 132 may be formed on the core layer 110.

Meanwhile, the coating process as described above may be performed by a process of compressing a film type sheet made of the second metal-resin composite with respect to the core layer 110 and then curing the film type sheet. The process of compressing and curing the film type sheet may be adjusted so that conditions such as predetermined temperature, surface pressure, and degree of vacuum are satisfied. More specifically, in the process of curing the film type sheet, a curing temperature may be adjusted to be about 170 to 200° C. In the case in which the curing temperature is less than 170° C., it may be difficult to completely cure a multilayer material, and in the case in which the curing temperature exceeds 200° C., the resin of the magnetic layer 130 may be degraded. The surface pressure may be adjusted to be about 0.05 to 20 kgf. In the case in which the surface pressure is less than 0.05 kgf, pressure applied to the multilayer material is low, such that the multilayer material may not be effectively covered on the surface of the core layer 110, and in the case in which the surface pressure exceeds 20 kgf, the core substrate 110 may be deformed due to excessive pressing. In addition, the degree of vacuum may be a condition required for removing a residual solvent in the magnetic layer 130 at the time of forming the magnetic layer 130. To this end, the degree of vacuum may be adjusted to be 1 torr or less.

Then, the external electrode 140 may be formed on a resultant article in which the cover layer 134 is formed (S160). In the forming of the external electrode 140, the metal layer electrically connected to the conductive pattern 120 formed on the core layer 110 may be formed on both end portions of the resultant article by performing a plating process, a dipping process, and the like, on the resultant article.

The inductor 100 manufactured by the above-mentioned process may have a structure in which the magnetic material filling density of the filled part 132 of the magnetic layer 130 is relatively increased, such that inductance characteristics are improved. More specifically, referring to the following Table 1, a content of the resin in the first metal-resin composite for manufacturing the filled part 132 of the inductor 100 was adjusted to be 2.0 wt %, 2.5 wt %, 3.5 wt %, 4.5 wt %, and 5.0 wt % to relatively adjust a content of a magnetic material. In this case, it was confirmed that in the case in which the content of the resin in the first metal-resin composite was adjusted to be 3.5 wt % or less to increase the content of the magnetic material, inductance characteristics of a manufactured inductor satisfy a reference value. Particularly, it was confirmed that in the case in which the content of the resin in the first metal-resin composite was adjusted to be 2.5 wt % or less, inductance characteristics of a manufactured inductor are improved by 10% or more as compared with a reference value. On the other hand, it was confirmed that in the case in which the content of the resin in the first metal-resin composite was adjusted to be higher than 3.5 wt %, inductance characteristics of a manufactured inductor are not satisfied. The reason is that the magnetic material filling density of the filled part of the magnetic layer is less than 5.49 g/cm³, such that magnetic permeability is less than a reference value.

Therefore, it may be preferable that the magnetic filling density of the filled part 132 of the inductor 100 is about 5.49 g/cm³ or more with respect to the filled part 132, and it may be preferable that the content of the resin in the metal-resin composite for manufacturing the filled part 132 is less than about 3.5 wt % based on the metal-resin composite.

TABLE 1

| Content of resin (wt %) | Filling density (g/cm³) | Inductance (L) |
|---|---|---|
| 2 | 5.52 | ◯ |
| 2.5 | 5.51 | ◯ |
| 3.5 | 5.49 | Reference |
| 4.5 | 5.46 | X |
| 5 | 5.41 | X |

 Inductance (L)→◯: 10% or more as compared with reference/X: less than 10% as compared with reference

As described above, in the method for manufacturing an inductor according to the exemplary embodiment of the present invention, after the core layer 110 having the conductive pattern 120 formed on the surface thereof and having the through-hole 112 formed at a region in which the conductive pattern 120 is not formed is manufactured, the filled part 132 filled in the through-hole 110 and the cover part 134 other than the filled part 132 are formed by separate processes, respectively. Here, the filled part 132 may be formed using the metal-resin composite having the relatively high magnetic material content. In this case, generally, the magnetic material filling density of the filled part 132 may be increased as compared with the case in which the filled part 132 and the cover part 134 are formed by a single process using the same composite. Therefore, in the method for manufacturing an inductor according to the exemplary embodiment of the present invention, after the filled part formed in the core layer is formed using the composite having the relatively high magnetic material content, the cover part is formed by a separate process to improve the magnetic material filling density of the filled part, such that the entire magnetic permeability of the magnetic material is increased, thereby making it possible to manufacture an inductor having improved inductance characteristics.

Since the inductor according to the exemplary embodiment of the present invention has a structure in which the magnetic layer filled in the core layer has relatively high magnetic material filling density, it may have a structure in which magnetic permeability thereof is increased to improve inductance characteristics.

In the method for manufacturing an inductor according to the exemplary embodiment of the present invention, after the filled part formed in the core layer is formed using the composite having the relatively high magnetic material content, the cover part is formed by a separate process to improve the magnetic material filling density of the filled part, such that the entire magnetic permeability of the magnetic material is increased, thereby making it possible to manufacture an inductor having improved inductance characteristics.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An inductor comprising:
a core layer having a conductive pattern formed on a surface thereof and having a through-hole formed at a region in which the conductive pattern is not formed; and
a magnetic layer covering the core layer,
wherein the magnetic layer includes:
a filled part filled in the through-hole and having high magnetic material filling density; and
a cover part covering the surface of the core layer and having magnetic material filling density lower than that of the filled part.

2. The inductor according to claim 1, wherein each of the filled part and the cover part is made of a metal-resin composite, and
the magnetic material filling density of the filled part is 5.49 g/cm³ or more.

3. The inductor according to claim 1, wherein a content of a resin in a metal-resin composite for manufacturing the filled part is less than 3.5 wt % based on the metal-resin composite.

4. The inductor according to claim 1, wherein the filled part and the cover part are made of a metal-resin composite,
the metal-resin composite including a metal containing iron (Fe) and a thermosetting resin.

5. The inductor according to claim 1, wherein the filled part is formed by filling a metal-resin composite in the through-hole before the cover part is formed.

6. The inductor according to claim 1, wherein the filled part and the cover part contact each other while forming an interface therebetween.

7. A method for manufacturing an inductor, comprising:
preparing a core substrate;
preparing a core layer by forming a through-hole in the core substrate;
forming a filled part in the through-hole by filling a first metal-resin composite in the through-hole, the first metal-resin composite having a relatively high magnetic material content; and
forming a cover part by forming a second metal-resin composite on the core layer and the filled part, the second metal-resin composite having a magnetic material content lower than that of the first metal-resin composite.

8. The method according to claim 7, wherein the first and second metal-resin composites include a metal containing iron (Fe) and a thermosetting resin, respectively, and
a content of the metal is higher in the first metal-resin composite than in the second metal-resin composite.

9. The method according to claim 7, wherein in the forming of the filled part, a screen printing process is performed on the core layer.

10. The method according to claim 7, wherein a content of a resin in the first metal-resin composite is less than 3.5 wt % based on the first metal-resin composite.

11. The method according to claim 7, wherein the preparing of the core layer includes:
preparing a copper clad laminate (CCL); and
forming the through-hole in the copper clad laminate.

12. The method according to claim 7, further comprising, before the forming of the cover part, patterning a metal layer formed on a surface of the core layer.

13. A method for manufacturing an inductor including a core layer having a conductive pattern formed on a surface thereof and having a through-hole formed at a region in which the conductive pattern is not formed, a magnetic layer including a filled part filled in the through-hole and a cover part other than the filled part, and an external electrode formed on an end portion of the magnetic layer, wherein the filled part is formed by a process separate from a process of forming the cover part before the process of forming the cove part.

14. The method according to claim 13, wherein the filled part has a high magnetic material content higher than that of the cover part.

15. The method according to claim 13, wherein the core layer is formed by forming the through-hole in a copper clad laminate and patterning a metal layer on a surface of the copper clad laminate.
